(19) United States
(12) Patent Application Publication
(10) Pub. No.: US 2006/0035586 A1
(43) Pub. Date: Feb. 16, 2006

(54) S-Ray universal CD recorder

(76) Inventor: Steven Ray Jernigan, Hebbronville, TX (US)

Correspondence Address: Steven Ray Jernigan, Apt # 211-A, 508 N. Dagmar, Hebbronville, TX, 78361, US

(21) Appl. No.: 10/731,205

(22) Filed: Aug. 13, 2004

(51) Int. Cl. H04H 7/00

(52) U.S. Cl. 455/3.06

(57) ABSTRACT

This invention is modular which allows users to custom design the system to best suit their wants and needs. Which until now was not possible. It also allows easy future upgrades to new media and broadcast types and a voice interactive system control interface. The S-Ray automotive entertainment system takes advantage of all available media and broadcast services and combines them into a compact unit. New upgrades and options can be be continually obtained by the user which prevents the unit from becoming obsolete. Options such as LCD touch screen, in dash hands free cell system for the vehicle. The device plays and records DVD, DVD/R, Flash storage, CD-Rom and CD/RW media. It receives and allows the user to record from, AM/FM/XM/TV/CB and Shortwave broadcast as well as from one type of media to another using an onboard hard disc drive storage system.

### SUMMARY OF THE INVENTION

What makes this invention unique is that it is modular which allows users or installers to custom design the entertainment system to meet a specific need or want as well as allow easy future upgrades to new media and broadcast types along with a voice interactive system control interface.

The S-Ray automotive entertainment system takes advantage of all available media and broadcast services and combines them into a double-din, w/LCD touch screen option, in dash system for the vehicle.

The device plays and records DVD, DVD/R, Flash storage, CD-Rom and CD/RW media.

It receives and allows the user to record from, AM/FM/XM and TV broadcast as well as from one type of media to another using an onboard hard disc drive storage system. The system is modular which allows custom easy future upgrades to new media and broadcast types along with a voice interactive system control interface.

Key Points

User interchangeable card modules

Continuously upgradeable

128 bit wide buss architecture allows for future processor upgrades

All components reside on plug in card modules

### DESCRIPTION OF DRAWINGS

FIG. 1—Proposed Interchangable faceplate design with color LCD screen.

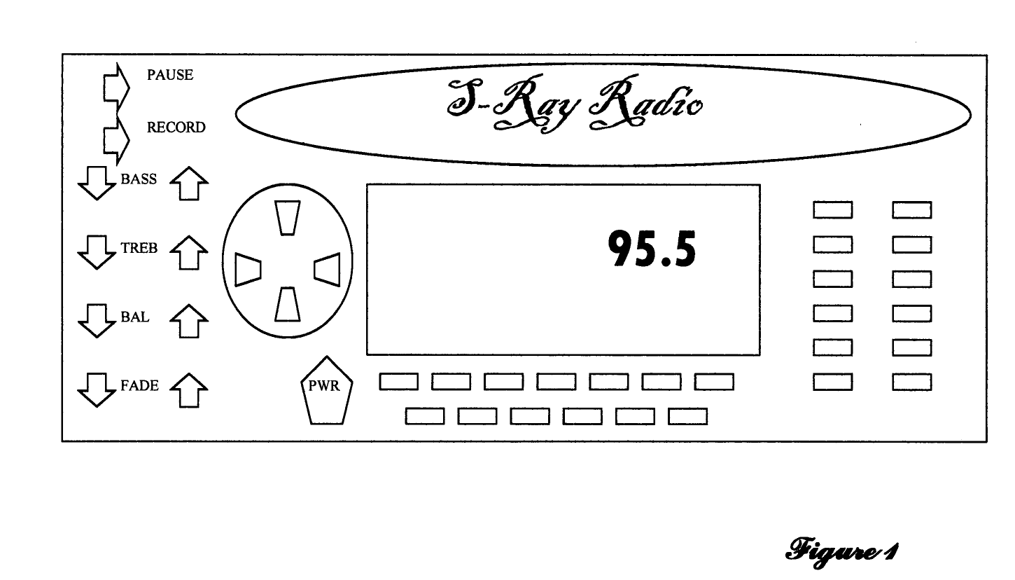

FIG. 2.—Shows the proposed lay out of the mainboard that all card/modules will plug in to.

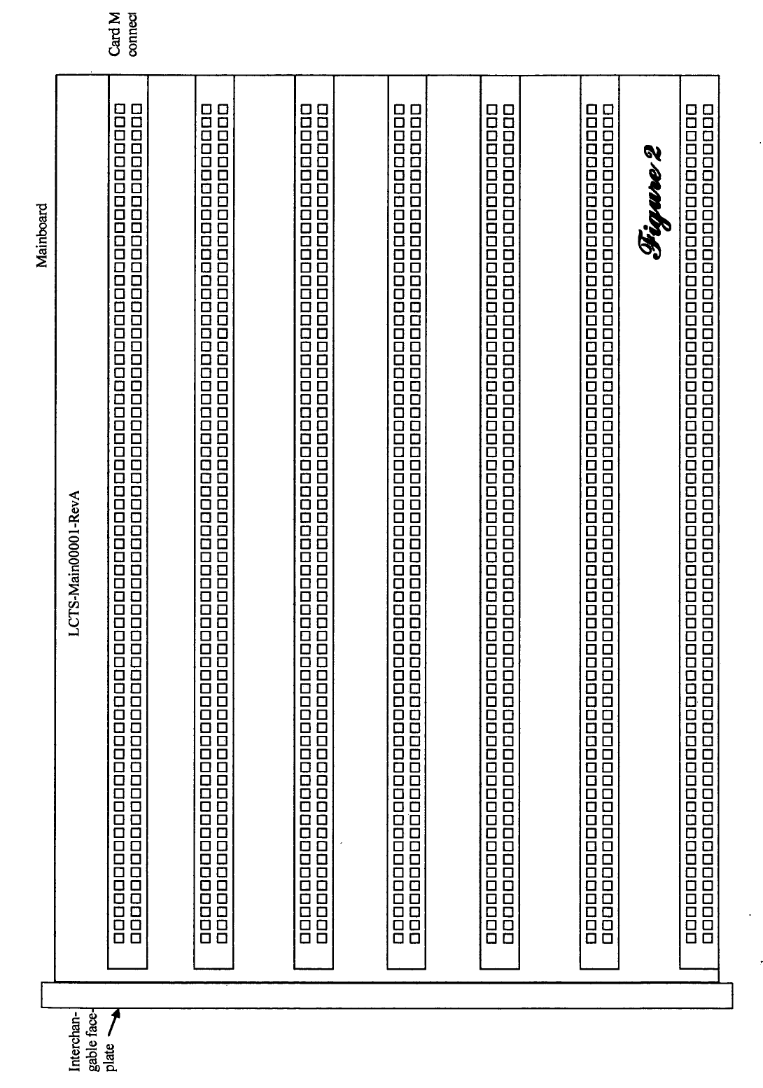

FIG. 3—Demonstrates how the different modules will plug in to the main board.

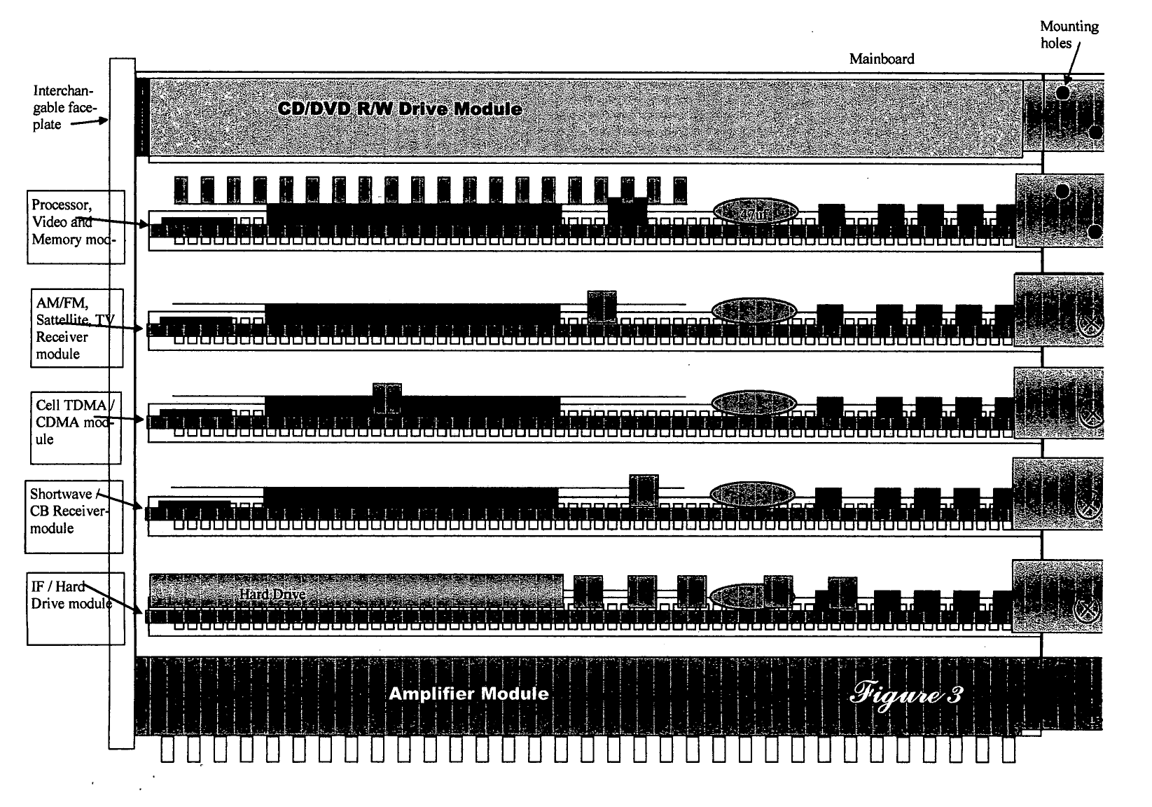

FIG. 4—Illustrates possible pc run layouts for the mainboards construction.

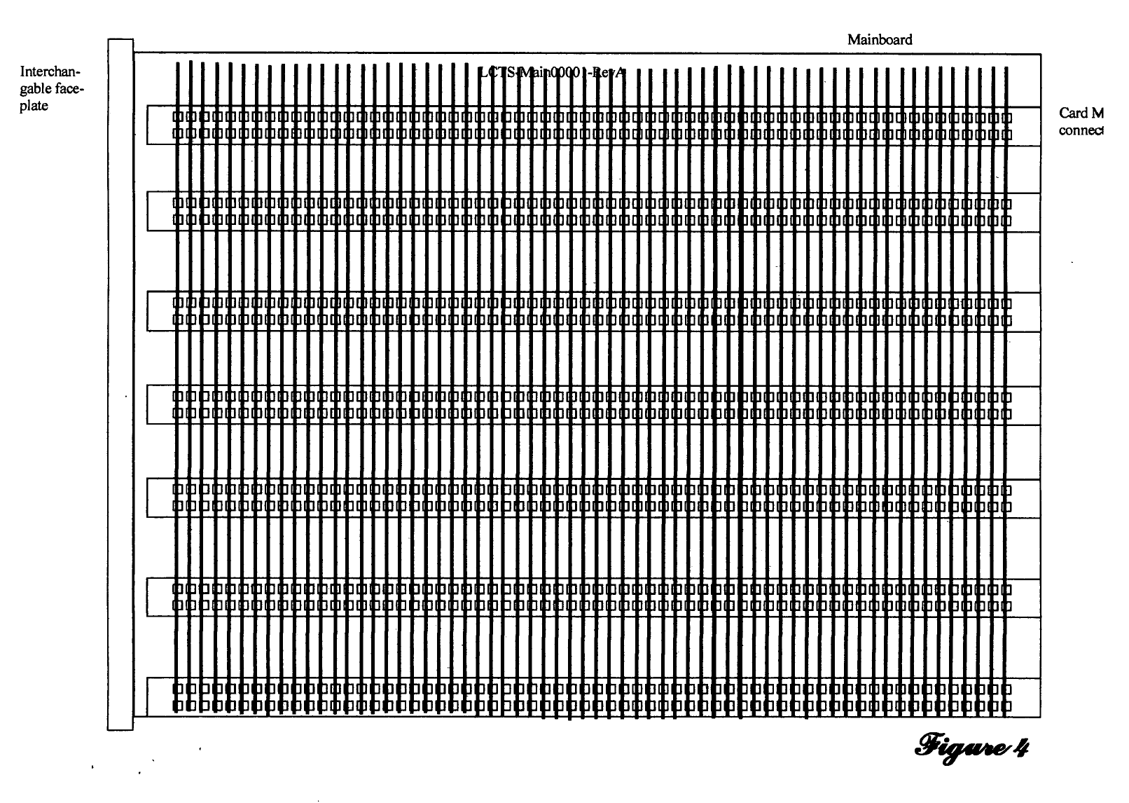

FIG. 5—Shows the populated rear panel connections for the different modules installed.

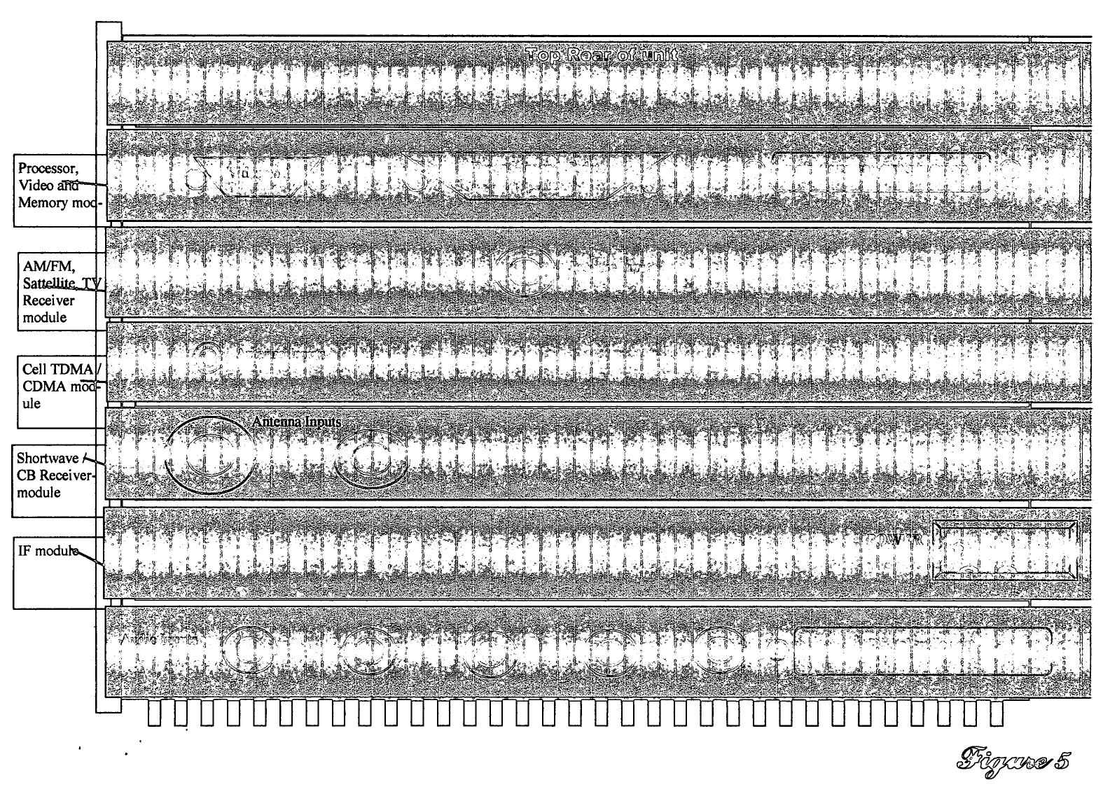

FIG. 6—Provides an overall outside view of where the various components will be mounted within the unit.

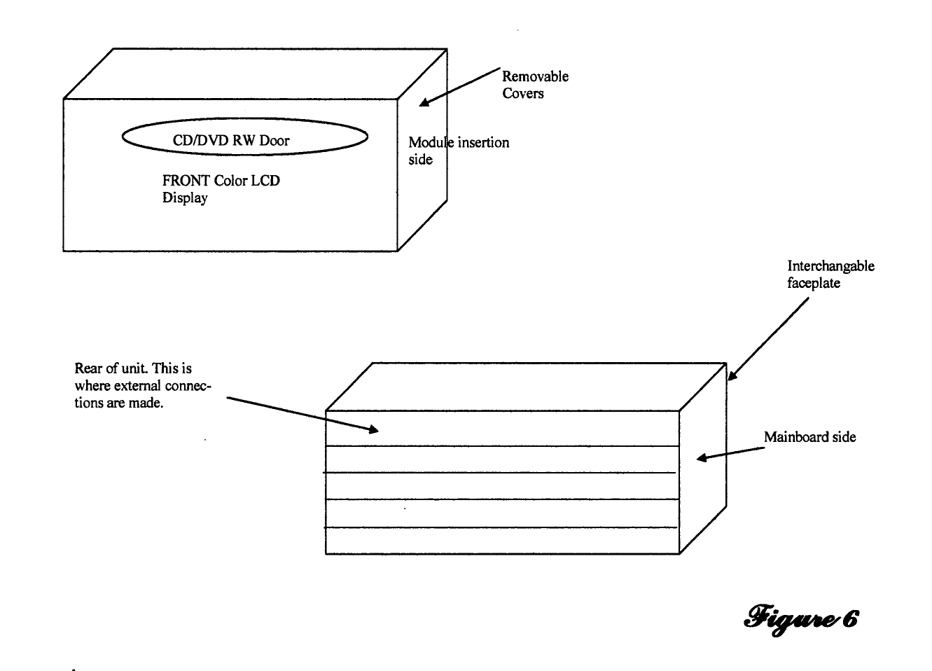

FIG. 7—Schematic Diagram of System

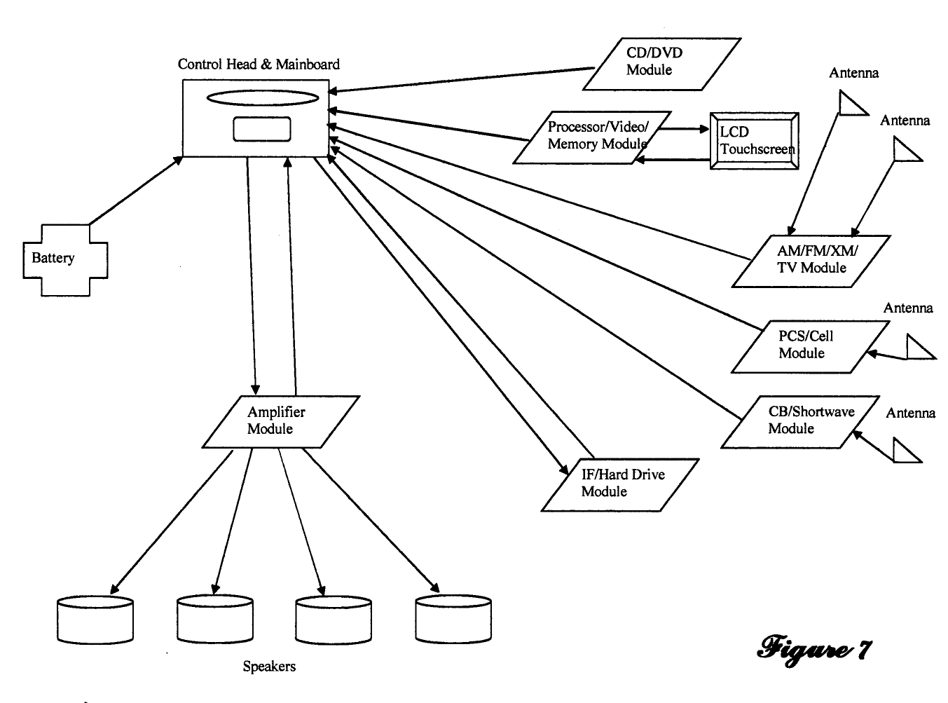

We claim:

1. The invention is the modular design of the system allowing the user to easily and continually change or upgrade or add on to the system.

2. The S-Ray Automotive entertainment system will play and record to all modern available media including but not limited to; DVD, DVD/R, Flash storage, CD-Rom and CD/RW media.

3. It will receive and allow the user to record unprotected, AM/FM/XM/ICB and Shortwave broadcast to all current CD/DVD type media.

4. That the system will be software driven and can be controlled by an optional touch-screen LCD monitor.

5. The system is modular in construction which allows users to custom design the entertainment system to meet their wants or needs including different PCS/cell phone cards for different cell phone providers.

6. The Intergrated hands free cell phone module allows users to answer and make calls without taking their hands off the wheel.

7. The system allows for easy upgrades such as to new media and broadcast types, and a voice interactive system control interface.

8. The system can record from one type of media to another using an onboard hard disc drive storage system.

9. This system to be user upgradeable using plug-in modules.
